(19) United States
(12) Patent Application Publication
(10) Pub. No.: US 2025/0077917 A1
(43) Pub. Date: Mar. 6, 2025

(54) SYSTEMS AND METHODS FOR ITERATIVE GENERATION AND PLOTTING OF MACHINE LEARNING OUTCOMES ON A USER INTERFACE

(71) Applicant: Charles Schwab & Co., Inc, San Francisco, CA (US)

(72) Inventors: Randal Scott HOWELL, Omaha, NE (US); Nicholas THEODORAKOS, Chicago, IL (US)

(73) Assignee: Charles Schwab & Co., Inc, San Francisco, CA (US)

(21) Appl. No.: 18/953,548

(22) Filed: Nov. 20, 2024

Related U.S. Application Data
(63) Continuation of application No. 16/588,553, filed on Sep. 30, 2019.

(51) Int. Cl. G06N 5/046; G06Q 40/06

(52) U.S. Cl. CPC G06N 5/046; G06Q 40/06

(57) ABSTRACT

A system includes at least one processor and a memory. The memory stores an account database and a scenario database. Each scenario includes a set of rules to apply to account parameters to determine adjusted account parameters. The memory stores instructions that, upon execution, cause the at least one processor to, in response to receiving a request including a first scenario of the set of scenarios, identify a first set of rules from the scenario database corresponding to the first scenario. The instructions cause the processor to obtain first account parameters of the first account and adjust the first account parameters based on the first set of rules. The instructions cause the processor to calculate a set of outcome metrics of the first account based on the adjusted account parameters and plot the set of outcome metrics based on a plot type included in the request.

### CROSS-REFERENCE TO RELATED APPLICATIONS

This application is a continuation of U.S. patent application Ser. No. 16/588,553, filed Sep. 30, 2019, the entire disclosure of which is incorporated herein by reference.

### FIELD

The present disclosure relates to computer-generated user interfaces and more particularly to systems and methods for generating graphical representations of machine learning outcomes.

### BACKGROUND

Accounts and investments may be analyzed according to various risk factors to determine if a particular account or particular investments exceed a threshold risk factor. Since account holders do not have the ability to perform these risk assessments, internal associates perform the risk assessments. Then internal associates provide account holders individually with risk exposure information to initiate mitigation techniques to bring accounts within tolerance levels. Such a dynamic between account holders and associates is time consuming and creates friction.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system includes at least one processor and a memory coupled to the at least one processor. The memory stores an account database including a plurality of accounts. Each account of the plurality of accounts includes account parameters. The memory stores a scenario database including a set of scenarios. Each scenario of the set of scenarios includes a set of rules to apply to account parameters to determine adjusted account parameters based on the respective scenario. The memory stores instructions that, upon execution, cause the at least one processor to, in response to receiving a request including a first scenario of the set of scenarios, identify a first set of rules from the scenario database corresponding to the first scenario. The request indicates a first account of the plurality of accounts. The instructions cause the at least one processor to obtain first account parameters of the first account and adjust the first account parameters based on the first set of rules. The instructions cause the at least one processor to calculate a set of outcome metrics of the first account based on the adjusted account parameters and plot the set of outcome metrics based on a plot type included in the request.

In other features, the memory stores a historical database including investment value trends over a historical period. The set of outcome metrics are calculated based on the investment value trends for investments included in the first account. In other features, account parameters include (i) a set of investment identifiers of the first account and (ii) a value corresponding to each investment identifier. In other features, the system includes a threshold database including a plurality of thresholds. Each threshold of the plurality of thresholds corresponds to a respective outcome metric.

In other features, the instructions, upon execution, cause the at least one processor to, in response to the request indicating an alert check, select a set of accounts from the plurality of accounts, and the set of accounts are identified in the request. The instructions further cause the at least one processor to, for each account of the set of accounts, calculate a first outcome metric and identify a first threshold stored in the threshold database. The first threshold corresponds to the first outcome metric. In response to the first outcome metric being beyond the first threshold, the instructions cause the at least one processor to generate and transmit a first alert.

In other features, the request includes: (i) a request type, (ii) an account identifier, (iii) a requested investment group identifier, (iv) a requested scenario identifier, and (v) a requested account adjustment parameter. In other features, the request type indicates a requested plot type. In other features, the instructions, upon execution, cause the at least one processor to, in response to the request indicating a hypothetical metrics request, identify a first parameter of the first account of the request to adjust and adjust the first parameter based on a requested account adjustment parameter. The instructions further cause the at least one processor to calculate the set of outcome metrics based on the adjusted first parameter and display the calculated set of outcome metrics.

In other features, the instructions, upon execution, cause the at least one processor to display the set of outcome metrics. In other features, the set of outcome metrics includes at least one of: (i) a margin call amount, (ii) a deficiency ratio, (iii) a deficiency amount, (iv) an exposure amount, (v) a profit vector, and (vi) a loss vector.

A method includes, in response to receiving a request including a first scenario of a set of scenarios, identifying a first set of rules from a scenario database corresponding to the first scenario. The request indicates a first account of a plurality of accounts. Each account of the plurality of accounts includes account parameters. Each scenario of the set of scenarios includes a set of rules to apply to account parameters to determine adjusted account parameters based on the respective scenario. The method includes obtaining first account parameters of the first account and adjusting the first account parameters based on the first set of rules. The method includes calculating a set of outcome metrics of the first account based on the adjusted account parameters and plotting the set of outcome metrics based on a plot type included in the request.

In other features, the method includes storing a historical database including investment value trends over a historical period. The set of outcome metrics are calculated based on the investment value trends for investments included in the first account. In other features, account parameters include (i) a set of investment identifiers of the first account and (ii) a value corresponding to each investment identifier. In other features, the method includes storing a plurality of thresholds in a threshold database. Each threshold of the plurality of thresholds corresponds to a respective outcome metric.

In other features, the method includes, in response to the request indicating an alert check, selecting a set of accounts from the plurality of accounts. The set of accounts are identified in the request. The method includes, for each account of the set of accounts, calculating a first outcome metric. The method includes identifying a first threshold stored in the threshold database. The first threshold corresponds to the first outcome metric. The method includes, in response to the first outcome metric being beyond the first threshold, generating and transmitting a first alert.

In other features, the request includes: (i) a request type, (ii) an account identifier, (iii) a requested investment group identifier, (iv) a requested scenario identifier, and (v) a requested account adjustment parameter. In other features, the request type indicates a requested plot type. In other features, the method includes, in response to the request indicating a hypothetical metrics request, identifying a first parameter of the first account of the request to adjust and adjusting the first parameter based on a requested account adjustment parameter. The method includes calculating the set of outcome metrics based on the adjusted first parameter and displaying the calculated set of outcome metrics.

In other features, the method includes displaying the set of outcome metrics. In other features, the set of outcome metrics includes at least one of: (i) a margin call amount, (ii) a deficiency ratio, (iii) a deficiency amount, (iv) an exposure amount, (v) a profit vector, and (vi) a loss vector.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a high-level block diagram of an example network communication system including an outcome management system according to the principles of the present disclosure.

FIG. 2 is an example request sent by a user or entity to request an alert check, obtain outcome metrics, or plot results of a potential scenario.

FIG. 3 is an example user interface plot displaying projected outcomes according to a potential scenario being applied to investments of a particular account.

FIG. 4 is an example user interface distribution plot displaying return distribution after a potential scenario is applied to a particular account.

FIG. 5 is an example user interface displaying example deficiency ratio alert settings and example exposure alert settings adjustable by a user.

FIG. 6 is an example user interface displaying an example deficiency ratio alert and an example exposure alert.

FIG. 7 is a functional block diagram of operation of an example outcome management device.

FIG. 8 is a flowchart depicting example operation of generating an alert based on outcome metrics.

FIG. 9 is a flowchart depicting example operation of displaying outcome metrics.

In the drawings, reference numbers may be reused to identify similar and/or identical elements.

### DETAILED DESCRIPTION

An outcome management system projects outcomes and generates alerts based on calculated outcome metrics related to risk analytics. The alerts are generated for a particular user based on account holder or user preferences. For example, account holder or user preferences may be set according to user input, in real time, at predetermined intervals, etc. The particular user may also project outcomes of potential scenarios using the outcome management system. Based on investments of the particular user's account and scenarios applied to the particular user's account, the outcome management system can display the projected outcome of the particular account in response to an occurrence of a potential scenario. The user may apply selected potential scenarios using the outcome management system to their particular account as a whole or to particular investments included in the account.

In various implementations, the user, as well as an entity associated with the outcome management system, may set alert rules for their particular account. The alert rules are set to generate an alert when the tolerance threshold (for example, a threshold risk value) is passed. As an example, the alert rules may be set to alert the user when the particular user's account falls below a set deficiency ratio, indicating that a margin call amount that may be requested of the particular user exceeds a liquidation amount. The user may also generate a scenario to apply to their account to calculate potential risk metrics based on an adjustment to their account parameters, such as a change in investments.

In various implementations, to generate alerts in a timely manner, the outcome management system automatically calculates outcome metrics for user accounts in real time or at predetermined intervals, which may be hourly, daily, etc. As the alert thresholds may be set by both the particular user and the entity, the outcome management system may request that the alerts set by the particular user are at least as conservative as those set by the entity, providing a similar buffer.

Users may also project outcomes in graphical representations to determine how a potential scenario would affect their account or particular investments. For example, users may apply the potential scenario to a set of investments (for example, tech investments, automotive investments, etc.) to project the outcome of their investments if the potential scenario were to occur. The set of scenarios applied to user accounts may include market stress tests, such as an idiosyncratic stress test, a beta-weighted fully correlated stress test, or customs stress tests applied to individual or groups of investments.

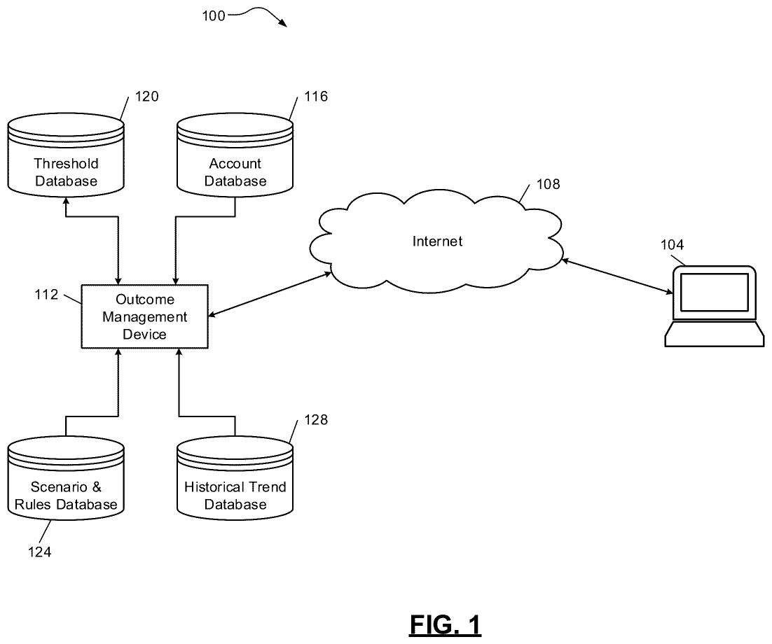

FIG. 1 shows a high-level block diagram of an example network communication system including an outcome management system 100. A user device 104 communicates via Internet 108 with an outcome management device 112. In various implementations, the user device 104 may interact directly with the outcome management device 112 using an internal network connection.

In response to the user device 104 providing a request to the outcome management device 112, the outcome management device 112 accesses a plurality of databases to fulfill the request. For example, the request may be to provide outcome metrics for the user's account, provide potential outcome metrics for the user's account when an account parameter is adjusted, or generate a plot illustrating metrics if a potential scenario were to occur. The outcome management device 112 further provides alerts in response to one of the outcome metrics of the user's account passing a threshold risk value.

In various implementations, the outcome management device 112 periodically (for example, everyday) generates present outcome metrics for each account stored in an account database 116. The stored accounts correspond to users maintaining an account with an entity associated with the outcome management device 112. In various implementations, the entity may operate a financial trading platform, a loan providing platform, or another financial platform. While the user operates and adjusts the outcome management device 112, the entity may additionally or alternatively perform the operations and changes that the user is performing.

Each account includes account parameters, such as account value, present investments, type of investments, etc. The outcome management device 112 will periodically generate outcome metrics. The outcome metrics may include determining a margin call amount, a deficiency ratio, deficiency amount, Absolute Threshold Value (ATV), Possible Value Range (PVR), an exposure amount, profit or loss vector, idiosyncratic PVR loss, beta PVR loss, implied PVR, ATV/PVR ratio, cash balance versus liquidation value, net option value, short option unit, vega ratio, and a maintenance requirement. The outcome metrics indicate an amount of risk that the account poses to the entity or user.

The margin call or margin deficiency amount is an amount needed to bring an account above the entity's minimum equity maintenance requirement value. The deficiency ratio is equivalent to a margin call or margin deficiency amount divided by net liquidation value of an account. The deficiency ratio indicates the severity of the margin call. The deficiency amount is an amount of equity that an account is deficient to meet a total equity maintenance requirement in the account. If the account carries a deficiency overnight, then a margin call is issued. The ATV is a percentage change in an underlying investment or security within an account that would cause a loss equal to a liquidation value of that account. If the security were to have a return greater than the ATV, then the account would have a negative equity or become unsecured. For example, an unsecured account occurs when the net liquidation value of the account is negative, meaning that the account has negative equity or the position value is not enough to cover the margin loan.

The PVR is the entity's best estimate for a plausible but improbable one-day return for a given investment or security. The PVR is determined using historical volatility, implied volatility, liquidity, and expert opinion. Additional entity calculations include historical value at risk and implied volatility PVR. The PVR may be calculated based on the last five years of returns of the investment, which determines expected shortfall or value at risk. The outcome management device 112 also communicates with a historical trend database 124 to retrieve historical trends to calculate PVR.

The exposure amount is the amount of PVR loss that exceeds an account's liquidation value. The profit or loss vector are theoretical profit or loss based on a price change in an investment or security. Such a value may be beta weighted (correlated) to an index or given the PVR for the investment. The idiosyncratic PVR (iPVR) loss is a maximum loss amount within a risk array for an investment or group of investments. The beta PVR loss is the maximum loss amount within a risk array for an account. The implied PVR represents the entity's estimate for a plausible and improbable one-day return for an investment, based on the investment's options implied volatilities.

The ATV/PVR ratio is a degree of severity of exposure, indicating how close an account is to exposure. The cash balance to liquidation value is a ratio between the total cash balance of an account compared to the liquidation value of the account, indicating the account's carry risk. The net option value is a total value of all options within an account. The net option value is compared to other metrics, such as liquidation value. Short option unit assigns a minimum dollar requirement needed for every net short option position. An account has a net short option position when the account has more short options than long options. The vega ratio is a total account vega dollar amount divided by a net liquidation value. The maintenance requirement is the total amount house margin maintenance equity requirement needed to support an account.

When automatically operated, the outcome management device 112 generates the present outcome metrics to determine whether the present outcome metrics exceed or fall below a tolerance level or threshold determined by the user. When the outcome metrics pass a threshold risk value set by the user, the outcome management device 112 alerts the user and entity. The user may also set more conservative threshold risk values to alert only the user that a parameter of their account needs changing, such as supplying additional funds, making investment adjustments, etc. The threshold risk values are stored in a threshold database 120 for both the entity and user.

The outcome management device 112 may be configured to generate a plurality of alerts. The plurality of alerts include an urgent alert, an exposure alert, a deficiency ratio alert, a cash to net liquidation value ratio alert, an option expiration pin risk alert, and an option expiration exposure alert. The urgent alert is a high severity alert that requires remediation within one day. The urgent alert accounts for rules on a combination of risk metrics listed above, including ATV compared to PVR and iPVR, time to earnings, hotlist of stocks with volatility catalysts, and exposure amount. The exposure alert is based solely on the amount of exposure in an account, regardless of other risk metrics.

The deficiency ratio alert is based on the deficiency amount of an account divided by the account's net liquidation value. The cash to net liquidation value ratio alert is based on the cash balance amount of an account, debit or credit, divided by the account's net liquidation value. The option expiration pin risk alert is based on an investment price equal to an expiring option's stock price that is at risk of exercise (if long) or assignment (if short). The result of assignment or exercise would cause the account to be in a high exposure situation. The option expiration exposure alert is based on in-the-money expiring options that would cause an account to be in a high exposure situation.

In various implementations, the outcome management device 112 also accesses a scenario and rules database 128 to generate potential scenario outcomes. The user may select potential scenarios to apply to their account and generate graphical plots to convey how such a scenario would affect their account. The scenarios may include applying built-in stress tests such as idiosyncratic stress tests, beta-weighted fully correlated stress tests, and customizable stress tests that are adjustable by the user. The scenario and rules database 128 stores a set of rules for each scenario.

The idiosyncratic stress tests may have a set of rules that adjusts profits for each type of investment. There are also different types of idiosyncratic stress tests, for example, stressing the reduction in technology corporation profits by having rules changing only technology corporation investments due to a dot-com boom scenario or rules adjusting investments specifically related to home purchasing, emulating a decrease in federal interest rates scenario. These types of market stresses are example potential scenarios that influence a specific corporation (affecting account investments) or a select group of assets, which may influence user accounts differently. The idiosyncratic scenarios will affect selected indices by including rules directed to the selected indices failing, improving, or remaining unchanged.

The beta-weighted fully correlated stress tests may relate more generally to a particular index, such as the S&P 500, or a sector index. Beta-weighting a particular account weights each security in the account's portfolio by a beta value relative to the benchmark index. The outcome management device 112 may allow the user to enter their own beta values by security or the user can use the predetermined beta values calculated from the historical return data in the historical trend database 128.

The customizable stress tests adjust the user's portfolio based on the beta values input by the user or a specific account change that is input by the user. In various implementations, the user may also generate the outcome metrics for a customizable stress test or one of the built-in stress tests.

The account database 116, the threshold database 120, the historical trend database 124, and the scenario and rules database 128 are shown as communicating with the outcome management device 112 through an internal communications network. In various implementations, the account database 116, the threshold database 120, the historical trend database 128, and the scenario and rules database 124 may communicate with the outcome management device 112 via the Internet 108.

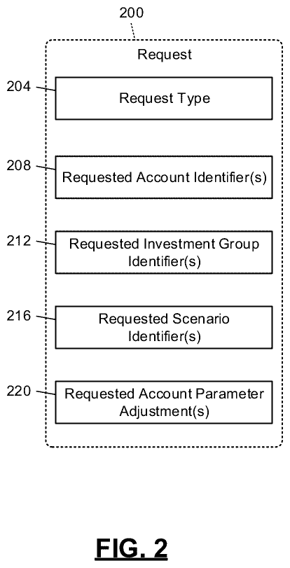

FIG. 2 shows an example request sent by a user or entity to request an alert check, obtain outcome metrics, or plot results of a potential scenario. A request 200 includes a request type 204, indicating whether the request 200 is for an alert check, to obtain outcome metrics (using present account parameters or adjusted account parameters), or to graph the outcome metrics after applying a potential scenario to account parameters of a particular account. For example, a particular user may determine whether their account parameters generate alerts. In addition, the entity may determine whether any user account generates alerts at predetermined intervals. In various implementations, when the request type is to graph outcome metrics resulting from application of the potential scenario, the request type 204 also indicates which type of plot to display. The type of plot may display profit and loss vectors, return distributions, or other predetermined displays of the outcome metrics in graphical form. The parameters of the request may be input into the request 200 via a dropdown menu user interface (UI) display.

The request 200 also includes a requested account identifier(s) 208. If the particular user requested analysis of their account, the requested account identifier(s) 208 identifies the particular user's account. Alternatively, if the entity is determining whether account parameters dictate the generation of alerts, the requested account identifier(s) 208 may identify all user accounts and generate the request 200 at predetermined intervals. In various implementations, a subset of accounts may be identified as well. The request 200 further includes a requested investment group identifier(s) 212 that identifies which portion of the user accounts is being analyzed. The requested investment group identifier(s) 212 may include all account investments, recent or long-term investments, a type of investment group (such as technology), etc.

The request 200 also includes a requested scenario identifier(s) 216 and a requested account parameter adjustment(s) 220. The requested scenario identifier(s) 216 may be empty when the user is requesting outcome metrics, present or potential. However, when the user is requesting graphical representation of the application of scenarios to their account, the request 200 indicates which scenario(s) to apply to the account. In various implementations, if the user is requesting the application of multiple scenarios to their account, separate graphs are generated and displayed in separate windows to the user. Similarly, the requested account parameter adjustment(s) 220 may be empty when the user is generating outcome metrics for their present account. However, when the user is applying a scenario, custom or otherwise, the request includes the user adjusted parameters (including how much the parameters are changing) from user input (customized scenario) or automatically (built-in scenario).

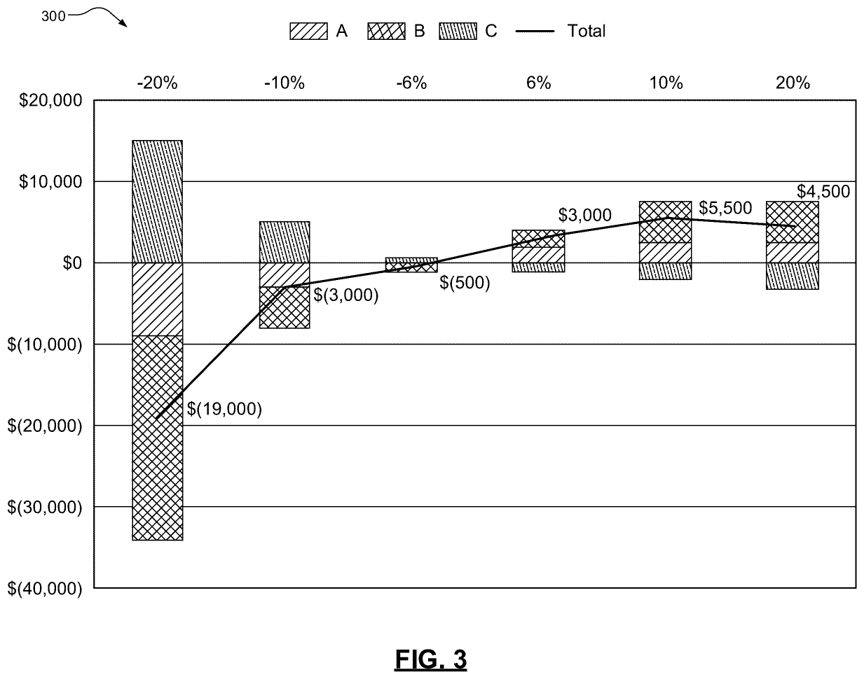

FIG. 3 shows an example user interface plot 300 displaying projected outcomes according to a potential scenario being applied to investments of a particular account. The example user interface plot 300 is the result of the outcome management system applying the potential scenario (a beta-weighted fully correlated stress test scenario) to the particular user account and plotting the resulting individual investments A, B, and C, along with a total. The example user interface plot 300 depicts the theoretical profit and loss as a result of the stress percentage in a particular index, for example, the S&P 500. The total line depicts the total aggregate account profit and loss of each investment within the particular account.

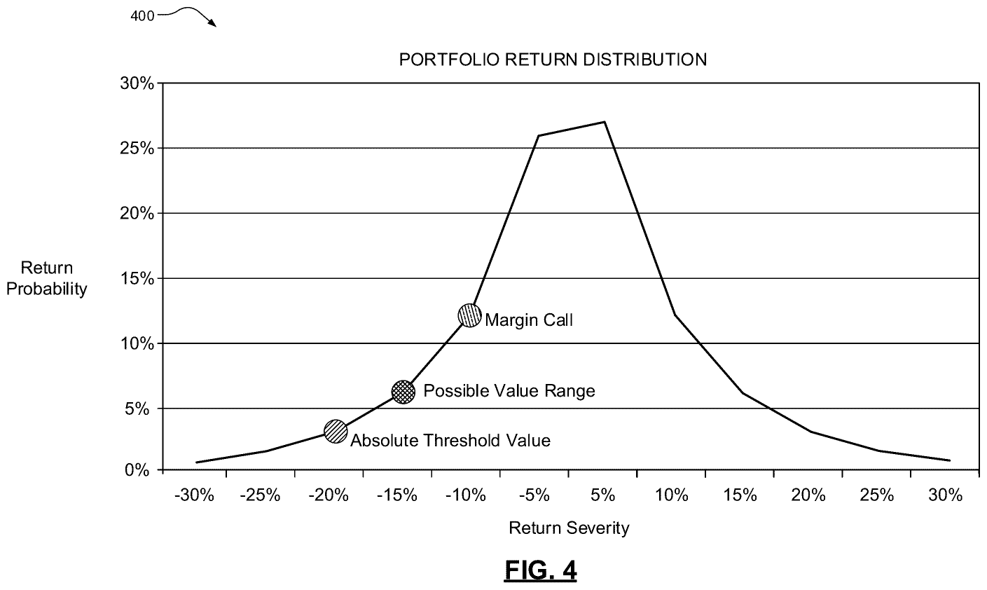

Referring now to FIG. 4, an example user interface distribution plot 400 displaying return distribution after a potential scenario is applied to a particular account is shown. The example user interface distribution plot 400 depicts a probability and severity distribution along the plotted line after application of the potential scenario to the particular account. Additional outcome metrics, such as ATV, PVR, and margin call, are also displayed along the graph.

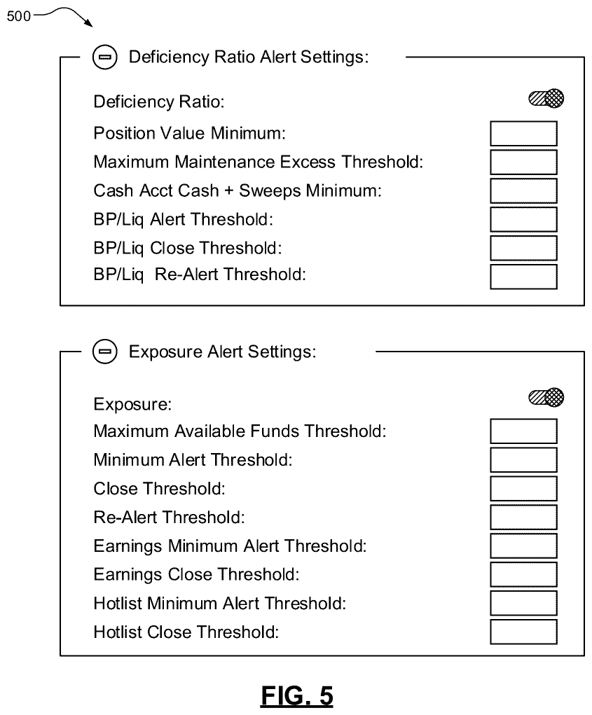

FIG. 5 shows an example user interface 500 displaying example deficiency ratio alert settings and example exposure alert settings adjustable by a user. The deficiency ratio alert settings are input by the user for their account. The outcome management system provides an option for the user to input more conservative alerts for when the user's account requires action to bring the account within guidelines set out by the entity, for example, having a minimum balance. Setting a more conservative alert for personalized alert settings allows the user to avoid a situation where the entity takes action before the user is notified of an issue. The same applies to exposure alert settings.

In various implementations, the alert is displayed to the user on a personal computing device when the user logs into their personalized account to manage their investments. The alert may also be transmitted to a mobile computing device of the user in response to the entity running their daily (or other predetermined interval) alert check. Included in the alert may be a prepopulated selection of closing orders that will result in a reduced exposure metric or deficiency ratio. Additionally, the alert may prompt the user to meet a margin call by liquidation.

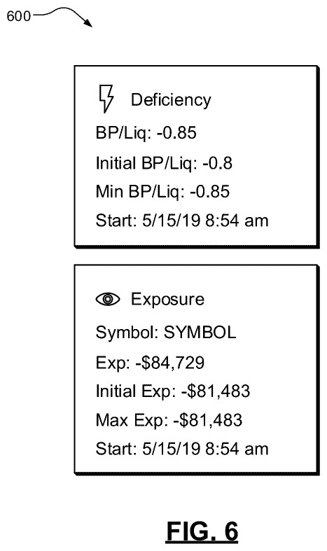

FIG. 6 shows an example user interface 600 displaying an example deficiency ratio alert and an example exposure alert. The example user interface 600 provides the user with relevant threshold information, initial balance, and exposure information within the alerts.

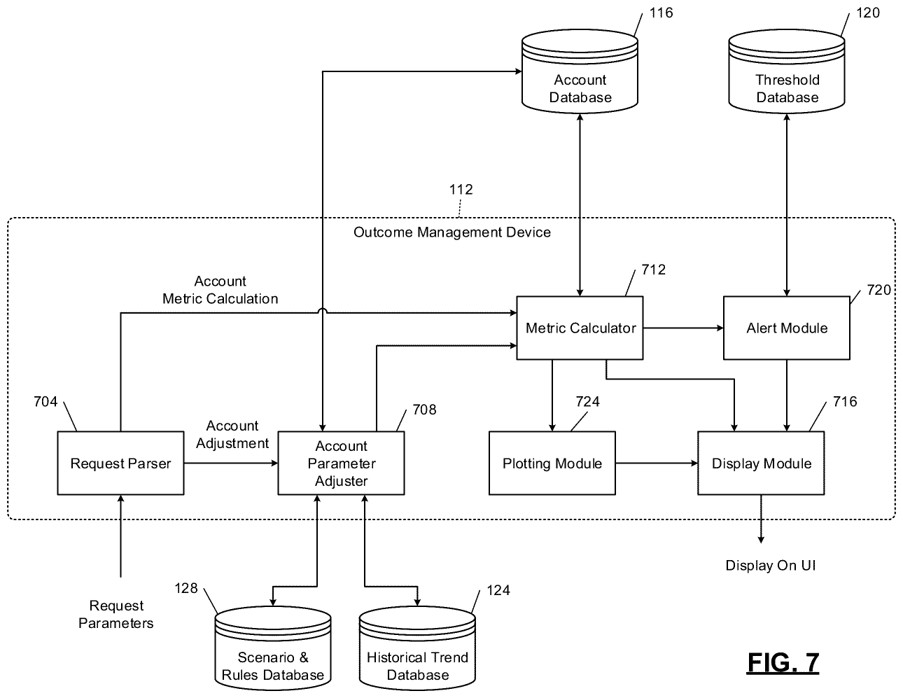

Referring now to FIG. 7, a functional block diagram of operation of an example outcome management device is shown. The outcome management device 112 includes a request parser 704 that receives request parameters from a user, for example, an entity representative or a user associated with an account being analyzed. The request parameters indicate the type of outcome requested by the user. If the user is requesting outcome metrics after applying a potential scenario, the request parser 704 transmits the request parameters to an account parameter adjuster 708 to adjust the account identified in the request based on the request type. The account parameter adjuster 708 retrieves present account information of the requested account identifier from the account database 116 as well as rules from the scenario and rules database 128 that correspond to the requested potential scenario. That is, if the user requests the potential scenario of beta-weighting the S&P 500 by a particular beta value, the account parameter adjuster 708 will weigh the percentage of each S&P 500 investment in the user's account by the particular beta value to determine the adjusted account parameters.

Otherwise, if the request parser 704 determines that the request type is to calculate present outcome metrics for the requested account, the request parser 704 transmits the request to a metric calculator 712. The metric calculator 712 retrieves present account parameters of the requested account identifier from the account database 116. The metric calculator 712 calculates the outcome metrics previously described using account parameters included in the request, in this case, the present account parameters. The outcome metrics are transmitted to a display module 716 for display on a user interface of a user device.

The metric calculator 712 also receives adjusted account parameters from the account parameter adjuster 708 when the user requests outcome metrics for their account under a potential scenario. The metric calculator 712 calculates the outcome metrics based on the adjusted account parameters and transmits the outcome metrics to the display module 716 for display on the user interface. In various implementations, the metric calculator 712 also transmits outcome metrics to an alert module 720 and a plotting module 724.

The alert module 720 retrieves threshold alert values from the threshold database 120. The alert module 720 compares the presently calculated outcome metrics to the threshold alert values to generate an alert when the outcome metrics pass one or more of the threshold alert values. The generated alert is transmitted to the display module 716 for display to the user associated with the account. In various implementations, the request parameters indicate that outcome metrics for a set of accounts are to be calculated to determine whether an alert should be generated, resulting in the metric calculator 712 only transmitting information to the display module 716 when an alert is generated.

When the request indicates an account parameter change, the account parameter adjuster 708 may not retrieve any rules. For example, if the user were to request a graph of their account profits and losses if they were to purchase $10,000 of investment A, the account parameter adjuster 708 would instead retrieve only historical trend information, including a present value, of investment A from the historical trend database 124 to include in the plot. The account parameter adjuster 708 retrieves the historical trend information for the adjusted account parameters and, if requested, retrieves the rules associated with the selected scenario for application to the account to adjust the account parameters. Then, the metric calculator 712 receives the adjusted account parameters to calculate the outcome metrics. The plotting module 724 receives the calculated outcome metrics and generates a plot of the account information according to the requested plot type included in the request type and based on the adjusted account parameters. The requested plot type may be one of the example graphs shown in FIGS. 3 and 4. The plotting module 724 then transmits the plot to the display module 716 for display.

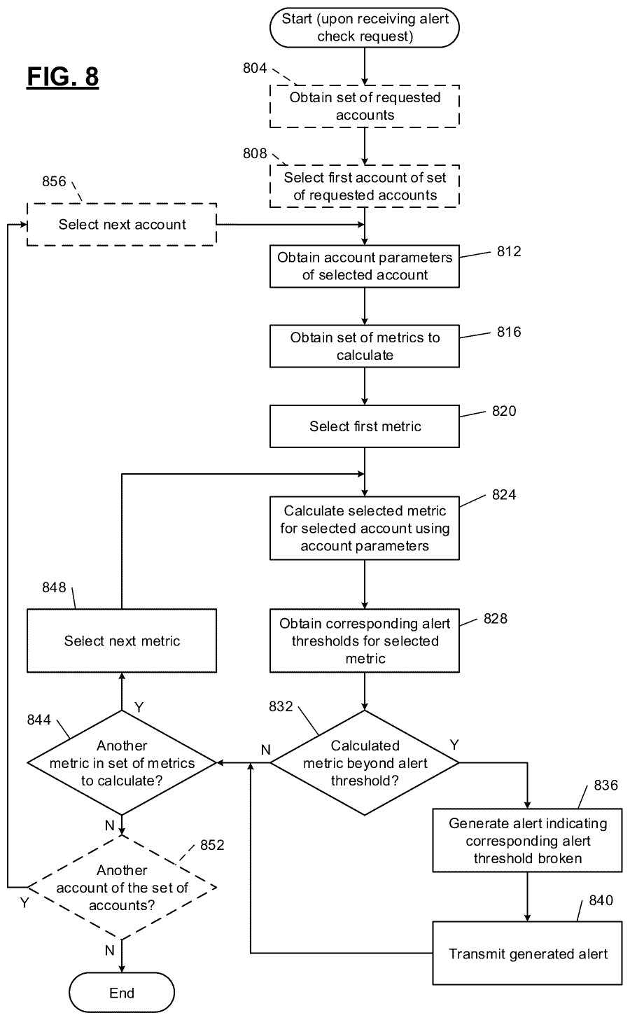

FIG. 8 is a flowchart depicting example operation of generating an alert based on outcome metrics. Control begins upon receiving an alert check request. At 804, when the entity is requesting the alert check request, control obtains a set of requested accounts. As mentioned previously, the request identifies the set of requested accounts. Additionally, the alert check request may be generated on behalf of the entity at predetermined intervals to determine if the parameters of an account pass a threshold risk metric, resulting in the generation of an alert. Optionally, control continues to 808, to select a first account of the set of requested accounts to cycle through each account.

For any alert check request, control continues to or begins at 812 to obtain account parameters of the selected (or requested) account. Control continues to 816 to obtain a set of metrics to calculate. The set of metrics includes the metrics listed previously, including a deficiency amount, an exposure amount, etc. At 820, control selects the first metric. Control continues to 824 to calculate the selected metric for the selected (or requested) account, using the obtained account parameters. At 828, control obtains corresponding alert threshold for the selected metric, including the user threshold and entity threshold.

Control proceeds to 832 to determine if the calculated metric is beyond the corresponding alert threshold. If yes, control continues to 836 to generate an alert, indicating that the corresponding alert threshold was broken, and transmits the generated alert at 840. Otherwise, control proceeds to 844 to determine if another metric is in the set of metrics to calculate. If yes, control selects the next metric at 848 and returns to 824. Otherwise, control proceeds to 852 or ends. When the alert check request is for a set of accounts (such as when the entity transmits the alert check request), control continues to 852. Otherwise, when the alert check request is for a single account, control ends. At 852, control determines if another account is included in the set of accounts. If yes, control proceeds to 856 to select the next account and return to 812. Otherwise, control ends.

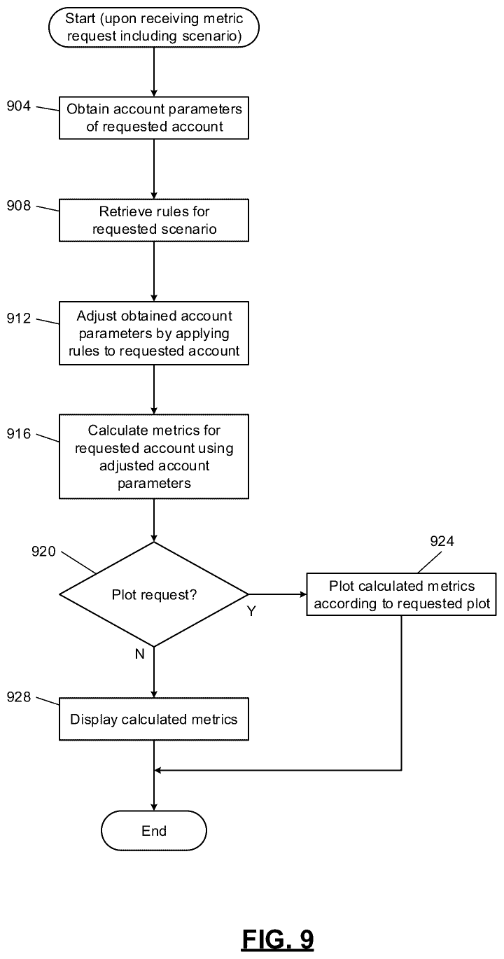

FIG. 9 is a flowchart depicting example operation of displaying outcome metrics. Control begins upon receiving a metric request including a scenario. At 904, control obtains account parameters of the requested account identified in the request. At 908, control retrieves rules for the requested scenario included in the request. At 912, control adjusts the obtained account parameters by applying the retrieved rules of the requested scenario to the account, for example, applying a beta-weighting fully correlated stress test, based on a default beta value, to a default index.

As mentioned previously, the adjustment of the obtained account parameters may not be directed to a scenario, such as beta-weighting, and instead includes adjusting account parameters to a specified parameter (for example, reducing a number of presently held investments to zero). Then, at 916, control calculates outcome metrics for the requested account using the adjusted account parameters. At 920, control determines whether the request included a plot request. If yes, control continues to 924 to plot the calculated metrics based on the requested plot and control ends. Otherwise, at 928, control displays the calculated metrics.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A, B, and C should be construed to mean a logical (A OR B OR C), using a non-exclusive logical OR, and should not be construed to mean “at least one of A, at least one of B, and at least one of C.” The term subset does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
at least one processor; and
a memory coupled to the at least one processor, wherein the memory stores an account database including a plurality of accounts, each account of the plurality of accounts including account parameters, a scenario database including a set of scenarios, each scenario of the set of scenarios including a set of rules to apply to account parameters to determine adjusted account parameters based on the respective scenario, and instructions that when executed by the at least one processor cause the system to perform,
receiving, from a first user via a user device, a request including a first scenario of the set of scenarios and in response to the receiving the request including the first scenario,
identifying a first set of rules from the scenario database corresponding to the first scenario, wherein the request indicates a first account of the plurality of accounts, the first account being an account of the first user,
obtaining first account parameters of the first account,
adjusting the first account parameters based on the first set of rules,
calculating a first set of outcome metrics of the first account based on the adjusted account parameters,
outputting the first set of outcome metrics,
sending an alert to the first user in response to an outcome metric to which at least one threshold corresponds, from among the first set of outcome metrics, exceeding the at least one threshold, and
generating a user interface at the user device that provides a plot of a profit or loss for each outcome metric of the first set of outcome metrics and a total line representing an aggregate profit or loss of the first set of outcome metrics in a first graph,
receiving, from the first user via the user device, a request for hypothetical metrics and in response to the receiving the request for the hypothetical metrics,
identifying a first parameter of the first account parameters identified in the request,
adjusting the first parameter based on a requested account adjustment parameter, the requested account adjustment parameter being a change to the first parameter, wherein the change is independent of any scenario of the set of scenarios,
calculating a second set of outcome metrics based on the adjusted first parameter, and
outputting the second set of outcome metrics to the user interface of the user device.

2. The system of claim 1, wherein
the memory stores a historical database including investment value trends over a historical period, and
the first set of outcome metrics are calculated based on the investment value trends for investments included in the first account.

3. The system of claim 1, wherein account parameters include a set of investment identifiers of the first account and a value corresponding to each investment identifier.

4. The system of claim 1, further comprising:
a threshold database including a plurality of thresholds,
wherein each threshold of the plurality of thresholds corresponds to a respective outcome metric.

5. The system of claim 4, wherein the instructions when executed by the at least one processor cause the system to perform, in response to the request indicating an alert check:
selecting a set of accounts from the plurality of accounts, wherein the set of accounts are identified in the request; and
for each account of the set of accounts,
calculating a first outcome metric,
identifying a first threshold stored in the threshold database, wherein the first threshold corresponds to the first outcome metric, and
in response to the first outcome metric being beyond the first threshold, generating and sending a first alert.

6. The system of claim 1, wherein
the request including the first scenario further includes at least one of a request type, an account identifier, a requested investment group identifier, or a requested scenario identifier, and
the request type indicates a requested plot type.

7. The system of claim 1, wherein the first set of outcome metrics and the second set of outcome metrics further include at least one of a deficiency ratio, a deficiency amount, an exposure amount, a profit vector, or a loss vector.

8. The system of claim 1, wherein the first set of outcome metrics and the second set of outcome metrics include an absolute threshold value of the first account, the absolute threshold value indicating a percentage change in an underlying security or investment within the first account that would cause a loss equal to a liquidation value of the first account.

9. The system of claim 1, wherein the instructions when executed by the at least one processor further cause the system to perform,
receiving, from the first user via the user device, a request to adjust user settings of an alert, and in response to the receiving the request to adjust the user settings of the alert,
obtaining, from the first user via the user device, first input for adjusting user settings of a metric alert to a user threshold,
alerting the first user by sending the metric alert to the user device in response to a metric passing the user threshold prior to the metric passing an entity threshold, and
outputting the metric alert in response to the first user logging in to the first account.

10. The system of claim 1, wherein
the user interface at the user device further provides a plot of a profit or loss for each outcome metric of the second set of outcome metrics and a total line representing an aggregate profit or loss of the second set of outcome metrics in a second graph, and
the first graph and the second graph are output to different windows of the user interface.

11. The system of claim 1, wherein the first graph additionally includes at least one of a plot of a probability and severity distribution or a display of one or more outcome metrics, the outcome metrics including an absolute threshold value, a possible value range, or a margin call.

12. A method comprising:
receiving, from a first user via a user device, a request including a first scenario of a set of scenarios and in response to the receiving the request including the first scenario,
identifying a first set of rules from a scenario database corresponding to the first scenario, wherein:
the request indicates a first account of a plurality of accounts, the first account being an account of the first user,
each account of the plurality of accounts includes account parameters, and
each scenario of the set of scenarios includes a set of rules to apply to account parameters to determine adjusted account parameters based on the respective scenario,
obtaining first account parameters of the first account,
adjusting the first account parameters based on the first set of rules;
calculating a first set of outcome metrics of the first account based on the adjusted account parameters,
outputting the first set of outcome metrics
sending an alert to the first user in response to an outcome metric to which at least one threshold corresponds, from among the first set of outcome metrics, exceeding the at least one threshold,
generating a user interface at the user device that provides a plot of a profit or loss for each outcome metric of the first set of outcome metrics and a total line representing an aggregate profit or loss of the first set of outcome metrics in a first graph,
receiving, from the first user via the user device, a request for hypothetical metrics; and
in response to the receiving the request for the hypothetical metrics,
identifying a first parameter of the first account parameters identified in the request,
adjusting the first parameter based on a requested account adjustment parameter, the requested account adjustment parameter being a change to the first parameter, wherein the change is independent of any scenario of the set of scenarios,
calculating a second set of outcome metrics based on the adjusted first parameter, and
outputting the second set of outcome metrics to the user interface of the user device.

13. The method of claim 12, further comprising:
storing a historical database including investment value trends over a historical period,
wherein the first set of outcome metrics are calculated based on the investment value trends for investments included in the first account.

14. The method of claim 12, wherein account parameters include a set of investment identifiers of the first account and a value corresponding to each investment identifier.

15. The method of claim 12, further comprising:
storing a plurality of thresholds in a threshold database, wherein each threshold of the plurality of thresholds corresponds to a respective outcome metric.

16. The method of claim 15, further comprising, in response to the request indicating an alert check:
selecting a set of accounts from the plurality of accounts, wherein the set of accounts are identified in the request;
for each account of the set of accounts, calculating a first outcome metric;
identifying a first threshold stored in the threshold database, wherein the first threshold corresponds to the first outcome metric; and
in response to the first outcome metric being beyond the first threshold, generating and sending a first alert.

17. The method of claim 12, wherein the request includes at least one of a request type, an account identifier, a requested investment group identifier, or a requested scenario identifier.

18. The method of claim 17, wherein the request type indicates a requested plot type.

19. The method of claim 12, wherein the first set of outcome metrics and the second set of outcome metrics further include at least one of: a deficiency ratio, a deficiency amount, an exposure amount, a profit vector, or a loss vector.

20. A system comprising:
at least one processor; and
a memory coupled to the at least one processor, wherein the memory stores an account database including a plurality of accounts, each account of the plurality of accounts including account parameters, a scenario database including a set of scenarios, each scenario of the set of scenarios including a set of rules to apply to account parameters to determine adjusted account parameters based on the respective scenario, and instructions that when executed by the at least one processor cause the system to perform,
receiving, from a first user via a user device, a request including a first scenario of the set of scenarios and in response to the receiving the request including the first scenario,
identifying a first set of rules from the scenario database corresponding to the first scenario, wherein the request indicates a first account of the plurality of accounts, the first account being an account of the first user,
obtaining first account parameters of the first account,
adjusting the first account parameters based on the first set of rules,
calculating a first set of outcome metrics of the first account based on the adjusted account parameters,
outputting the first set of outcome metrics,
sending an alert to the first user in response to an outcome metric to which at least one threshold corresponds, from among the first set of outcome metrics, exceeding the at least one threshold,
generating a user interface at the user device that provides a plot of a profit or loss for each outcome metric of the first set of outcome metrics and a total line representing an aggregate profit or loss of the first set of outcome metrics in a first graph, and
updating the first graph to include at least one of a plot of a probability and severity distribution or a display of one or more outcome metrics, the outcome metrics including an absolute threshold value, a possible value range, or a margin call, and
receiving, from the first user via the user device, a request for hypothetical metrics and in response to the receiving the request for the hypothetical metrics,
identifying a first parameter of the first account parameters identified in the request,
adjusting the first parameter based on a requested account adjustment parameter, the requested account adjustment parameter being a change to the first parameter, wherein the change is independent of any scenario of the set of scenarios,
calculating a second set of outcome metrics based on the adjusted first parameter, and
outputting the second set of outcome metrics to the user interface of the user device.
